(19) United States
(12) Patent Application Publication
(10) Pub. No.: US 2026/0350757 A1
(43) Pub. Date: Nov. 5, 2026

(54) NEURAL NETWORK-BASED IMAGE DENOISING

(71) Applicants: SAMSUNG ELECTRONICS CO., LTD., Suwon-si (KR); UIF (UNIVERSITY INDUSTRY FOUNDATION), YONSEI UNIVERSITY, Seoul (KR)

(72) Inventors: Bumsub HAM, Seoul (KR); Jeongwoo CHOI, Seoul (KR); Seunghoon LEE, Seoul (KR)

(73) Assignees: SAMSUNG ELECTRONICS CO., LTD., Suwon-si (KR); UIF (UNIVERSITY INDUSTRY FOUNDATION), YONSEI UNIVERSITY, Seoul (KR)

(21) Appl. No.: 19/638,744

(22) Filed: Apr. 3, 2026

(30) Foreign Application Priority Data
Apr. 24, 2025 (KR) 10-2025-0054097

(51) Int. Cl. G06T 5/70; G06N 3/0495; G06N 3/084

(52) U.S. Cl. CPC G06T 5/70; G06N 3/0495; G06N 3/084

(57) ABSTRACT

An electronic device may include a memory storing one or more instructions to operate a first neural network model and a second neural network model, and a processor configured to execute the one or more instructions to generate a first image by performing a plurality of denoising operations included in a target denoising group among a plurality of denoising groups, via the first neural network model, generate a second image by performing the plurality of denoising operations included in the target denoising group, via the second neural network model, and determine parameters of the second neural network model corresponding to the target denoising group, based on a comparison between the first image and the second image.

### CROSS-REFERENCE TO RELATED APPLICATION

This application is based on and claims priority under 35 U.S.C. § 119 to Korean Patent Application No. 10-2025-0054097, filed on Apr. 24, 2025, in the Korean Intellectual Property Office, the disclosure of which is incorporated by reference herein in its entirety.

### BACKGROUND

The present disclosure relates to an electronic device and an operating method of the same, and more particularly, to an electronic device for optimizing parameters of a neural network model for image processing (e.g., denoising processing), and an operating method of the same.

Recently, artificial intelligence systems that solve given problems using various neural network models have been actively developed. Unlike existing rule-based smart systems, artificial intelligence systems are capable of autonomous learning and decision-making, and are being utilized in a wide range of fields such as image processing, voice recognition, and future prediction. In particular, artificial intelligence systems are showing very high performance in image and video processing. Accordingly, the demand for on-device deep learning for image processing (e.g., denoising) in embedded systems is also increasing.

Therefore, in order to operate a neural network model (e.g., a quantized diffusion model) stably in embedded systems, it may be necessary to optimize parameters of the neural network model by considering errors accumulated during the image processing of the neural network model.

### SUMMARY

One or more embodiments provide an electronic device, an operating method of the same, and a system for optimizing parameters of a neural network model by considering errors accumulated in a plurality of image processing (e.g., denoising) operations.

In one or more embodiments of the present disclosure, an electronic device may include: a memory storing one or more instructions to operate a first neural network model and a second neural network model; and a processor configured to execute the one or more instructions to: generate a first image by performing a plurality of denoising operations included in a target denoising group among a plurality of denoising groups, via the first neural network model; generate a second image by performing the plurality of denoising operations included in the target denoising group, via the second neural network model; and determine parameters of the second neural network model corresponding to the target denoising group, based on a comparison between the first image and the second image.

In one or more embodiments of the present disclosure, an operating method of an electronic device may include: generating a first image by performing a plurality of denoising operations included in a target denoising group among a plurality of denoising groups, via a first neural network model; generating a second image by performing the plurality of denoising operations included in the target denoising group, via a second neural network model; and determining parameters of the second neural network model corresponding to the target denoising group, based on a comparison between the first image and the second image.

In one or more embodiments of the present disclosure, a system for performing denoising on an image may include: a memory storing one or more instructions to operate a first neural network model and a second neural network model, and a plurality of noise parameters respectively corresponding to a plurality of denoising operations; and a processor configured to execute the one or more instructions to: group an initial set of denoising operations into a plurality of denoising groups; identify a target denoising group among the plurality of denoising groups; generate a first image by performing the plurality of denoising operations included in the target denoising group, via the first neural network model; generate a second image by performing the plurality of denoising operations, via the second neural network model; and determine parameters of the second neural network model corresponding to the target denoising group, based on a loss function between the first image and the second image.

### BRIEF DESCRIPTION OF DRAWINGS

Embodiments of the present disclosure will be more clearly understood from the following detailed description taken in conjunction with the accompanying drawings in which:

FIG. 1 is a block diagram illustrating an electronic device in a network environment, according to an embodiment;

FIG. 2 is a block diagram of an electronic device according to an embodiment;

FIG. 3 is a diagram illustrating an operation of an electronic device, according to an embodiment;

FIG. 4 is a diagram illustrating an operation of an electronic device, according to an embodiment;

FIG. 5 is a diagram illustrating an operation of an electronic device, according to an embodiment;

FIG. 6 is a diagram illustrating an operation of an electronic device, according to an embodiment;

FIG. 7 is a flowchart illustrating an operating method of an electronic device, according to an embodiment;

FIG. 8 is a diagram for comparing an operation of an electronic device according to an embodiment with an operation of an electronic device according to a comparative example;

FIG. 9 is a diagram for comparing an operation of an electronic device according to an embodiment with an operation of an electronic device according to a comparative example;

FIG. 10 is a diagram for comparing an operation of an electronic device according to an embodiment with an operation of an electronic device according to a comparative example; and

FIG. 11 is a block diagram illustrating an electronic device according to an embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

In the present disclosure, the term “an embodiment” is intended to encompass one or more embodiments, rather than being limited to a single example. Furthermore, features described in embodiments may be combined and implemented together.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

Hereinafter, determining parameters of a neural network model (e.g., a second neural network model) may correspond to optimizing parameters of the neural network model (e.g., the second neural network model).

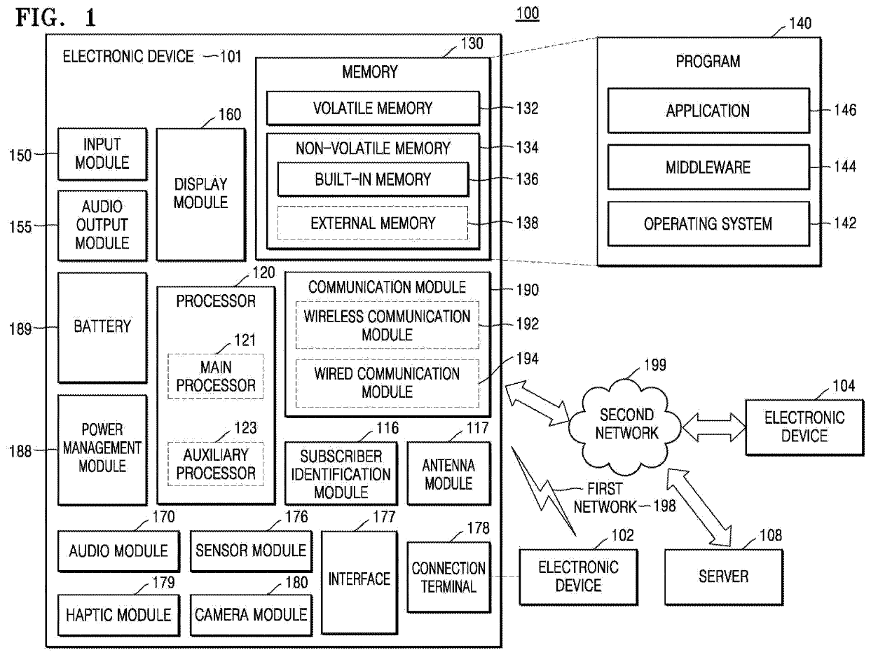

FIG. 1 is a block diagram illustrating an electronic device in a network environment, according to an embodiment.

Referring to FIG. 1, in a network environment 100, an electronic device 101 may communicate with an electronic device 102 through a first network 198 (e.g., a short-range wireless communication network), or may communicate with an electronic device 104 or a server 108 through a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, an audio output module 155, a display module 160, an audio module 170, a sensor module 176, an interface 177, a connection terminal 178, a haptic module 179, a camera module 180, a power management module 188, a battery 189, a communication module 190, a subscriber identification module 116, or an antenna module 117. In some embodiments, in the electronic device 101, at least one (e.g., the connection terminal 178) of these components may be omitted, or one or more other components may be added. In some embodiments, some (e.g., the sensor module 176, the camera module 180, or the antenna module 197) of these components may be integrated into one component (e.g., the display module 160).

The processor 120 may control at least one other component (e.g., a hardware or software component) of the electronic device 101 connected to the processor 120 by executing, for example, software (e.g., a program 140) and may perform various data processing or operations. According to an embodiment, as at least part of data processing or calculation, the processor 120 may store commands or data received from another component (e.g., the sensor module 176 or the communication module 190) in volatile memory 132, process the commands or data stored in the volatile memory 132, and store resulting data in non-volatile memory 134. The processor 120 may perform various image processing based on the neural network model.

The processor 120 according to an embodiment may perform denoising processing to remove noise from an input image using the neural network model, such as a diffusion model. A diffusion model is a type of generative model that gradually removes noise from an image through a series of iterative denoising steps, effectively reconstructing a clean image from a noisy input. The denoising processing may be divided into a plurality of denoising operations, each corresponding to a specific stage or degree of noise removal. The processor 120 may complete denoising processing by sequentially applying a plurality of denoising operations to the input image, gradually refining it over multiple steps. Hereinafter, the neural network model may refer to a neural network model for performing the denoising processing on the input image.

The processor 120 according to an embodiment may group all denoising operations required for the denoising processing (e.g., an initial set of denoising operations) into a predetermined number of denoising groups. For example, when a total number of denoising operations required for the denoising processing is T, the processor 120 may group the total T denoising operations into q denoising groups. For example, (T−1)th to (T-n)th denoising operations may be grouped into a first denoising group, and (n-1)th to 0th denoising operations may be grouped into an nth denoising group. The plurality of denoising operations included in each denoising group may share the parameters of the neural network model.

The processor 120 according to an embodiment may determine parameters of the neural network model for each denoising group by reflecting errors accumulated in the plurality of denoising operations. That is, the processor 120 may optimize the parameters of the neural network model for each denoising group by determining parameters by reflecting accumulated errors occurring in each denoising group.

In an embodiment, the processor 120 may determine the parameters of the neural network model for each denoising group, based on a gradient of a loss function for each denoising group. The loss function may represent a difference value (i.e., the error value of the neural network model) between an output image of a reference neural network model (e.g., a full precision model) and an output image of the (target) neural network model (e.g., the diffusion model). The reference neural network model may correspond to a full-capacity or teacher model, using high numerical precision (e.g., 32-bit floating-point computations) or complex architecture, and the target neural network model may correspond to a more compact or student model. The full precision model may have a greater precision than the target neural network model. The processor 120 may determine (or optimize) the parameters of the neural network model for each denoising group so that the image generated by the neural network model is identical to or similar to the image generated by the reference neural network model.

The processor 120 may calculate the gradient of the loss function through backpropagation from the loss function. However, in order to calculate the gradient of the loss function, intermediate gradients may be stored in the memory 130, which may require a significant amount of space (i.e., memory capacity) in the memory 130. Additionally, a backpropagation-based gradient calculation process may cause significant overload on the processor 120. In an embodiment, the processor 120 may optimize the parameters of the neural network model for each denoising group by determining the parameters of the neural network model based on an approximate value of an intermediate gradient of the loss function. For example, the processor 120 may calculate an approximate value of the intermediate gradient based on the noise parameters stored in the memory 130. The processor 120 may compute the approximate value of the intermediate gradient using the noise parameters associated with different denoising steps in the diffusion process. Rather than directly calculating the full gradient across multiple steps, the processor 120 may estimate the relationship between noisy images at different stages based on the noise parameters. Based on a ratio derived from the noise levels at two specific steps, the processor 120 may approximate the intermediate gradient between those steps. This approximation allows the overall gradient with respect to the model parameters to be estimated by scaling the gradient at an earlier step, significantly reducing the computational complexity and memory requirements.

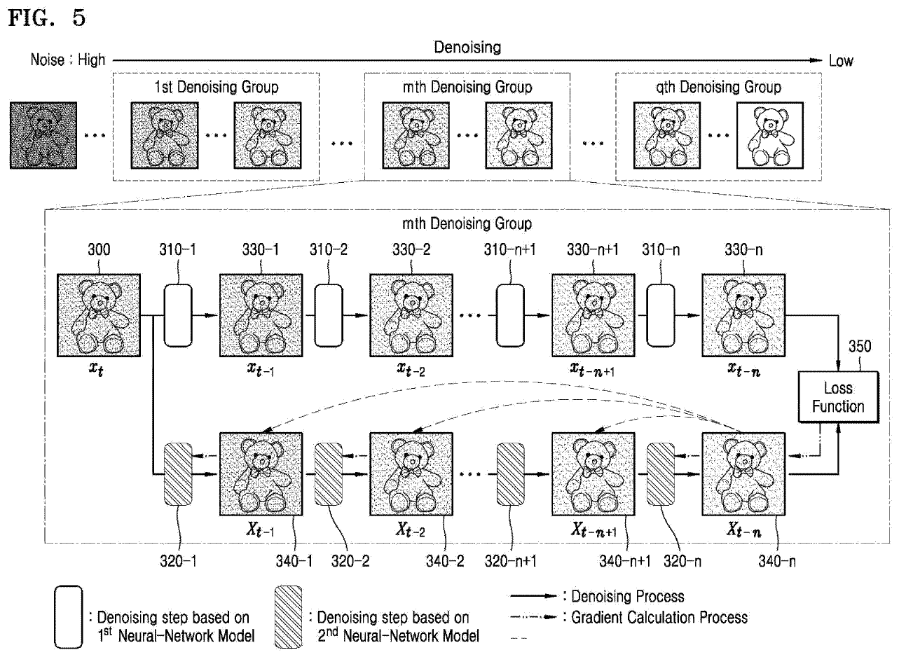

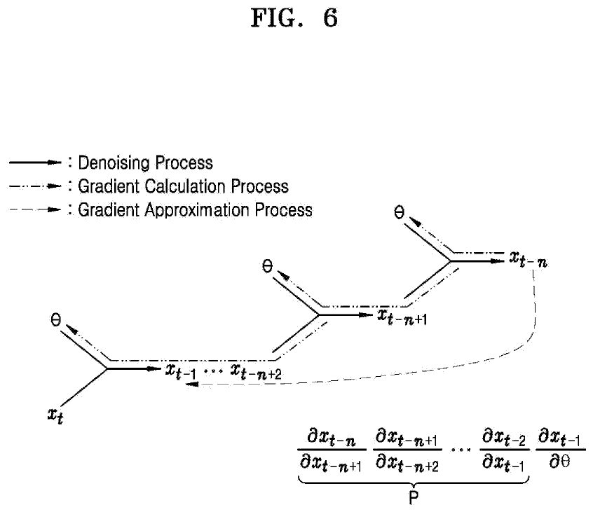

The processor 120 may determine (or optimize) the parameters of the neural network model for each denoising group based on the calculated approximate value of the intermediate gradient. The processor 120 according to an embodiment may maximize efficiency of resources (e.g., storage space of memory 220a) and prevent overload occurring during the calculation process of the gradient by optimizing the parameters of the neural network model for each denoising group based on the approximate value of the intermediate gradient. A detailed description of this is given below in FIGS. 5 and 6.

According to an embodiment, the processor 120 may include a main processor 121 (e.g., a central processing unit or an application processor) or an auxiliary processor 123 (e.g., a graphics processor, a neural processing unit (NPU), an image signal processor, a sensor hub processor, or a communications processor) that may operate independently or together with the main processor 121. For example, when the electronic device 101 includes the main processor 121 and the auxiliary processor 123, the auxiliary processor 123 may be configured to use lower power than the main processor 121 or to be specialized for a designated function. The auxiliary processor 123 may be implemented separately from the main processor 121 or as a part of the main processor 121.

The auxiliary processor 123 may control at least a portion of functions or states associated with at least one (e.g., the display module 160, the sensor module 176, or the communication module 190) of the components of the electronic device 101, for example, on behalf of the main processor 121 while the main processor 121 is in an inactive (e.g., sleep) state, or together with the main processor 121 while the main processor 121 is in an active (e.g., application execution) state. According to an embodiment, the auxiliary processor 123 (e.g., the image signal processor or the communication processor) may be implemented as a part of another functionally related component (e.g., the camera module 180 or the communication module 190). According to an embodiment, the auxiliary processor 123 (e.g., NPU) may include a hardware structure specialized for processing artificial intelligence models. The artificial intelligence models may be generated through machine learning. Such machine learning may be performed, for example, in the electronic device 101 itself on which artificial intelligence is performed, or may be performed through a separate server (e.g., the server 108). The learning algorithm may include, for example, supervised learning, unsupervised learning, semi-supervised learning, or reinforcement learning, for example, but is not limited thereto. The artificial intelligence model may include a plurality of artificial neural network layers. The artificial neural network may be any one or any combination of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, and a combination of two or more of the above, but is not limited thereto. The artificial intelligence model may additionally or alternatively include a software structure in addition to a hardware structure.

The memory 130 may store various data used by at least one component (e.g., processor 120 or sensor module 176) of the electronic device 101. The data may include, for example, input data or output data for software (e.g., the program 140) and instructions associated therewith. The memory 130 may include the volatile memory 132 or the non-volatile memory 134.

The program 140 may be stored as software in memory 130 and may include, for example, an operating system 142, a middleware 144, or an application 146.

The input module 150 may receive commands or data to be used in a component (e.g., processor 120) of the electronic device 101 from an external source of the electronic device 101 (e.g., a user). The input module 150 may include, for example, a microphone, a mouse, a keyboard, keys (e.g., buttons), or a digital pen (e.g., a stylus pen).

The audio output module 155 may output an audio signal to the outside of the electronic device 101. The audio output module 155 may include, for example, a speaker or a receiver. The speaker may be used for general purposes such as playing multimedia or playing recordings. The receiver may be used to receive incoming calls. According to an embodiment, the receiver may be implemented separately from the speaker, or as a part of the speaker.

The display module 160 may visually provide information to the outside (e.g., a user) of the electronic device 101. The display module 160 may include, for example, a display, a holographic device, or a projector and a control circuit for controlling the device. According to an embodiment, the display module 160 may include a touch sensor configured to detect a touch, or a pressure sensor configured to measure intensity of a force generated by the touch.

The audio module 170 may convert sound into an electrical signal, or vice versa, convert the electrical signal into the sound. According to an embodiment, the audio module 170 may acquire sound through the input module 150, or output sound through the audio output module 155, or an external electronic device (e.g., electronic device 102 (e.g., speaker or headphone)) directly or wirelessly connected to the electronic device 101.

The sensor module 176 may detect an operating status (e.g., power or temperature) of the electronic device 101 or an external environmental status (e.g., user status) and generate an electrical signal or data value corresponding to the detected status. According to an embodiment, the sensor module 176 may include, for example, a gesture sensor, a gyro sensor, a pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more designated protocols that may be used to allow the electronic device 101 to connect directly or wirelessly with the external electronic device (e.g., the electronic device 102). According to an embodiment, the interface 177 may include, for example, a high definition multimedia interface (HDMI), a universal serial bus (USB) interface, a secure digital (SD) card interface, or an audio interface.

The connection terminal 178 may include a connector through which the electronic device 101 may be physically connected to the external electronic device (e.g., the electronic device 102). According to an embodiment, the connection terminal 178 may include, for example, an HDMI connector, a USB connector, an SD card connector, or an audio connector (e.g., a headphone connector).

The haptic module 179 may convert an electrical signal into a mechanical stimulus (e.g., vibration or movement) or an electrical stimulus that a user may perceive through tactile or kinesthetic sensations. According to an embodiment, the haptic module 179 may include, for example, a motor, a piezoelectric element, or an electrical stimulation device.

The camera module 180 may capture still images and videos. According to an embodiment, the camera module 180 may include one or more lenses, image sensors, image signal processors, or flashes.

The power management module 188 may manage or control power supplied to the electronic device 101. According to an embodiment, the power management module 188 may be implemented, for example, as at least a part of a power management integrated circuit (PMIC).

The battery 189 may supply power to at least one component of the electronic device 101. According to an embodiment, the battery 189 may include, for example, a non-rechargeable primary battery, a rechargeable secondary battery, or a fuel cell.

The communication module 190 may support establishment of a direct (e.g., wired) communication channel or a wireless communication channel between the electronic device 101 and the external electronic device (e.g., the electronic device 102, the electronic device 104, or the server 108), and performance of communication through the established communication channel. The communication module 190 operates independently of the processor 120 (e.g., the application processor) and may include one or more communication processors that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication module). Among these communication modules, the corresponding communication module may communicate with an external electronic device 104 via the first network 198 (e.g., a short-range communication network such as Bluetooth, wireless fidelity (WiFi) direct, or infrared data association (IrDA)) or the second network 199 (e.g., a long-range communication network such as a legacy cellular network, a 5G network, a next-generation communication network, the Internet, or a computer network (e.g., the LAN or wide area network (WAN)). These different types of communication modules may be integrated into a single component (e.g., a single chip) or implemented as a plurality of separate components (e.g., a plurality of chips). The wireless communication module 192 may identify or authenticate the electronic device 101 within a communication network, such as the first network 198 or the second network 199, using subscriber information (e.g., international mobile subscriber identity (IMSI)) stored in the subscriber identification module 196.

The wireless communication module 192 may support 5G networks and next-generation communication technologies after a 4G network, for example, new radio (NR) access technology. The NR access technology may support high-speed transmission of high-capacity data (enhanced mobile broadband (eMBB)), minimizing terminal power and connecting multiple terminals (massive machine type communications (mMTC)), or ultra-reliable and low-latency communications (URLLC)). The wireless communication module 192 may support a high-frequency band (e.g., mmWave band) to achieve a high data transmission rate, for example. The wireless communication module 192 may support various technologies for securing performance in the high-frequency band, such as beamforming, massive multiple-input and multiple-output (MIMO), full dimensional MIMO (FD-MIMO), array antenna, analog beam-forming, or large scale antenna. The wireless communication module 192 may support various requirements specified in the electronic device 101, the external electronic device (e.g., the electronic device 104), or a network system (e.g., the second network 199). According to an embodiment, the wireless communication module 192 may support peak data rate (e.g., 20 Gbps or more) for eMBB realization, loss coverage (e.g., 164 dB or less) for mMTC realization, or U-plane latency (e.g., 0.5 ms or less for downlink (DL) and uplink (UL) each, or 1 ms or less for round trip) for URLLC realization.

The antenna module 197 may transmit or receive signals or power to or from an external source (e.g., the external electronic device). According to an embodiment, the antenna module 197 may include an antenna including a radiator made of a conductor or conductive pattern formed on a substrate (e.g., a PCB). According to an embodiment, the antenna module 197 may include a plurality of antennas (e.g., array antennas). In such a case, at least one antenna suitable for a communication method used in the communication network, such as the first network 198 or the second network 199, may be selected from the plurality of antennas, for example, by the communication module 190. The signal or power may be transmitted or received between the communication module 190 and the external electronic device via the at least one selected antenna. According to some embodiments, in addition to the radiator, other components (e.g., radio frequency integrated circuit (RFIC)) may be additionally formed as a part of the antenna module 197.

According to various embodiments, the antenna module 197 may form a mmWave antenna module. According to an embodiment, the mmWave antenna module may include a printed circuit board, an RFIC positioned on or adjacent a first surface (e.g., a bottom surface) of the printed circuit board and capable of supporting a designated high-frequency band (e.g., the mmWave band), and a plurality of antennas (e.g., an array antenna) positioned on or adjacent a second surface (e.g., a top surface or a side surface) of the printed circuit board and capable of transmitting or receiving signals in the designated high-frequency band.

At least some of the components may be interconnected via a communication method (e.g., a bus, a general purpose input and output (GPIO), a serial peripheral interface (SPI), or a mobile industry processor interface (MIPI)) between peripheral devices and exchange signals (e.g., commands or data) with each other

According to an embodiment, the commands or data may be transmitted or received between the electronic device 101 and the external electronic device 104 via the server 108 connected to the second network 199. Each of the external electronic devices 102 and 104 may be the same or a different type of device as the electronic device 101. According to an embodiment, all or part of the operations executed on the electronic device 101 may be executed on one or more external electronic devices among the external electronic devices 102, 104, and 108. For example, when the electronic device 101 is to perform a function or service automatically or in response to a request from a user or another device, the electronic device 101 may, instead of or in addition to executing the function or service on its own, request one or more external electronic devices to perform the function or at least a portion of the service. One or more external electronic devices that have received the request may execute at least a part of the requested function or service, or an additional function or service related to the request, and transmit the result of the execution to the electronic device 101. The electronic device 101 may provide the result, either as is or additionally processed, as at least part of a response to the request. For this purpose, for example, cloud computing, distributed computing, mobile edge computing (MEC), or client-server computing technologies may be used. The electronic device 101 may provide ultra-low latency services, for example, by using distributed computing or mobile edge computing. In an embodiment, the external electronic device 104 may include an internet of things (IoT) device. The server 108 may be an intelligent server utilizing machine learning and/or neural networks. According to an embodiment, the external electronic device 104 or the server 108 may be included in the second network 199. The electronic device 101 may be applied to intelligent services (e.g., smart home, smart city, smart car, or healthcare) based on 5G communication technology and IoT-related technology.

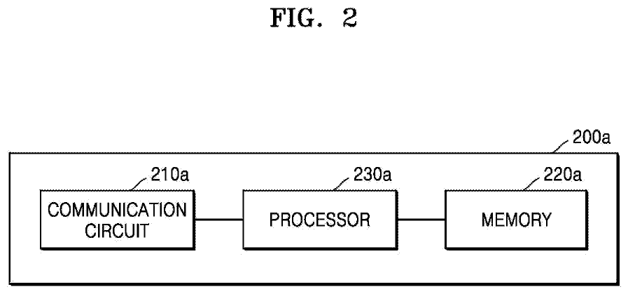

FIG. 2 is a block diagram of an electronic device according to an embodiment.

According to an embodiment, an electronic device 200a (e.g., the electronic device 101 of FIG. 1) (e.g., a PC or a server) may include a communication circuit 210a (e.g., the communication module 190 of FIG. 1), a memory 220a (e.g., the memory 130 of FIG. 1), and a processor 230a (e.g., the processor 120 of FIG. 1). According to various embodiments, the electronic device 200a may train the neural network model independently or through interactions with the external electronic device (e.g., the electronic devices 102 and 104 and the server 108 of FIG. 1). The neural network model may be stored entirely within the electronic device 200a, entirely in an external electronic device, or distributed between the electronic device 200a and the external electronic device. When the neural network model is stored partially or fully in the external electronic device, the electronic device 200a may perform training and/or execute the inference stage of the neural network model via the communication circuit 210a.

According to an embodiment, the communication circuit 210a may transmit and receive data with an external electronic device (e.g., the electronic devices 102 and 104 and the server 108 of FIG. 1). For example, the communication circuit 210a may transmit or receive images and/or video to the external electronic device.

According to an embodiment, memory 220a may include instructions executed by the processor 230a. The memory 220a may temporarily store images and/or videos received from the external electronic device or network.

According to an embodiment, the memory 220a may store a trained neural network model (e.g., the diffusion model) and the reference neural network model (e.g., the full precision model). The memory 220a may store data required for the processor 230a to execute instructions or the neural network model. For example, the memory 220a may store noise parameters required in a process of lightening the neural network model. For example, the memory 220a may store the plurality of denoising operations and the parameters of the neural network model corresponding to the plurality of denoising operations by mapping the plurality of denoising operations and the parameters of the neural network model to each other. Here, the noise parameters may represent a level of noise present in intermediate or output images generated by the neural network model during each of the plurality of denoising operations. For example, the noise level may correspond to the variance of Gaussian noise added at a specific denoising step, a beta schedule value, or a signal-to-noise ratio (SNR). Examples of the denoising operations may include executing neural network layers (e.g., convolutional filtering layers) trained to remove Gaussian or Poisson noise, applying score-based denoising functions, and using residual blocks configured to suppress high-frequency noise.

According to an embodiment, the memory 220a may store result data generated by the processor 230a executing instructions or a neural network model. For example, the memory 220a may store the image (i.e., an image with at least some noise removed) generated by the processor 230a performing at least one denoising operation based on the neural network model (e.g., the diffusion model).

According to an embodiment, the processor 230a may control the overall operation of the electronic device 200a. According to an embodiment, the processor 230a may train (or learn) the neural network model. According to various embodiments, a system for training the neural network model may be implemented internally in the electronic device 200a (e.g., the processor 230a), externally in the electronic device 200a, or in a combination of the electronic device 200a and an external device. According to an embodiment, the processor 230a may train the neural network model (e.g., the diffusion model) to remove noise included in the image. However, the processor 230a is not limited thereto, and may receive the trained neural network model (e.g., the diffusion model) from the external electronic device (e.g., the electronic devices 102 and 104, the server 108 of FIG. 1) through the communication circuit 210a.

Neural network models may be embedded in various embedded systems (e.g., smartphones, smart glasses, portable game consoles, intelligent surveillance cameras, etc.) to perform various image processing (e.g., denoising processing). According to an embodiment, the processor 230a may perform lightweighting (e.g., post-training quantization) of the trained neural network model to operate in a limited resource environment such as the embedded system. For example, the processor 230a may apply post-training quantization, which is a process that reduces the precision of the model parameters by converting high-precision weights and/or activation bits (e.g., 32-bit floating point) in the trained neural network model to low-density data (e.g., 6-bit data). The processor 230a according to an embodiment may group all denoising operations required for denoising processing into a certain number of denoising groups. These groups may correspond to different stages or types of noise reduction applied during the inference process.

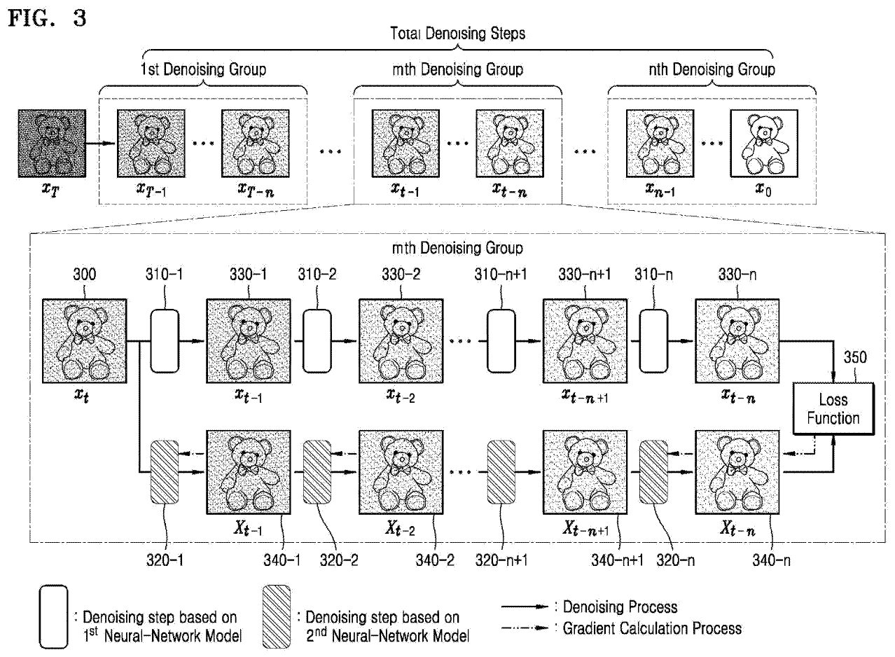

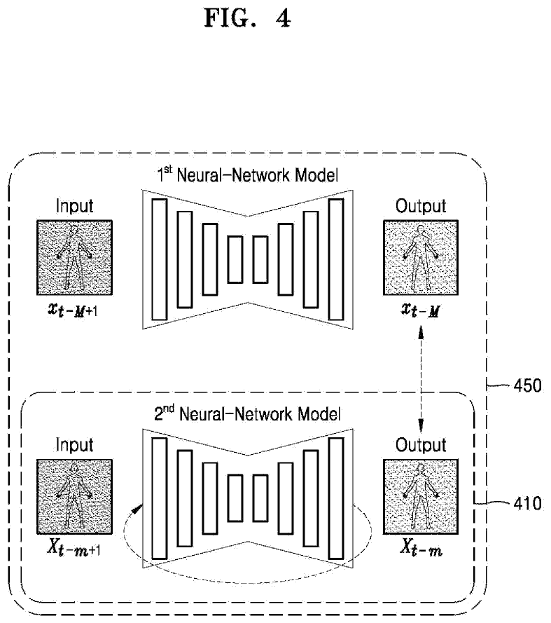

The processor 230a according to the embodiment may optimize the parameters of the neural network model for each denoising group by reflecting errors accumulated in the plurality of image processing operations by determining the parameters of the neural network model for each denoising group. Through this, the processor 230a according to the embodiment may precisely adjust the parameters of the neural network model for each denoising group, thereby improving image processing performance (e.g., denoising performance) of the neural network model (or the processor 230a). A detailed description of this is given below in FIGS. 3 and 4. Hereinafter, the parameters of the neural network model may refer to parameters related to the lightweighting of the neural network model (e.g., quantization parameters). In addition, below, determining the parameters of the neural network model for each denoising group may correspond to optimizing the parameters of the neural network model for each denoising group.

According to an embodiment, the processor 230a may determine the parameters of the neural network model for each denoising group based on the gradient of the loss function for each denoising group. Hereinafter, the loss function may refer to a function corresponding to the difference value (i.e., the error value of the neural network model) between an output image of the reference neural network model (e.g., the full precision model) and an output image of the neural network model (e.g., the diffusion model). That is, the processor 230a may determine the parameters of the neural network model for each denoising group so that a final image generated by performing the plurality of denoising operations by the neural network model is identical to or similar to a final image generated by performing the plurality of denoising operations by the reference neural network model. The processor 230a may calculate the gradient of the loss function through the backpropagation from the loss function. However, in this case, because the processor 230a calculates the gradient based on the intermediate gradients of each image processing (e.g., the denoising) operation, there is a problem that the memory 220a must secure memory space for storing the intermediate gradients. In addition, a process of calculating the gradient of the loss function based on the intermediate gradients causes a significant overload, which has the problem of lowering the performance of the processor 230a.

Accordingly, the processor 230a according to the embodiment may determine the parameters of the neural network model for each denoising group based on the approximate value of the intermediate gradient of the loss function for each denoising group. For example, the processor 230a may calculate the approximate value of the intermediate gradient of the loss function for each denoising group, based on the noise parameters stored in the memory 220a. The processor 230a may determine the parameters of the neural network model for each denoising group based on the calculated approximate value of the intermediate gradient. The processor 230a according to the embodiment determines (or optimizes) the parameters of the neural network model for each denoising group based on the approximate value of the intermediate gradient, thereby maximizing the efficiency of resources (e.g., storage space/capacity of the memory 220a) and preventing overload occurring during the calculation process of the gradient. A detailed description of this is given below in FIGS. 5 and 6.

According to various embodiments, the electronic device 200a may omit some of the components or may further include at least some of the components of the electronic device 101 illustrated in FIG. 1.

FIG. 3 is a diagram illustrating an operation of an electronic device, according to an embodiment.

In detail, FIG. 3 is a diagram for illustrating an operation of determining (optimizing) parameters of the neural network model by an electronic device according to an embodiment. Any description that overlaps with descriptions already given is omitted.

In FIG. 3, overall denoising operations for the overall denoising processing may be grouped into a predetermined number (e.g., q) by a processor of the electronic device. For example, among entire denoising operations, the denoising operations (T−1)th to (T-n)th may be grouped into the first denoising group, among the entire denoising operations, denoising operations (t−1)th to (t-n)th may be grouped into an m-th denoising group, and among the entire denoising operations, denoising operations (n−1)th to 0th may be grouped into a n-th denoising group. The processor may perform each denoising operation on the input image to generate an output image. For example, the processor may perform the (T−1)th denoising operation on an input image x_{T-1} to generate an output image X_{T-1}, and may perform a (T−2)th denoising operation on the input image x_{T}-1 to generate an output image x_{T-2}. As described above, the output image of the previous denoising operation may be input to a first neural network model or a second neural network model as the input image in the next denoising operation.

The reference neural network model (e.g., the full precision model) of FIGS. 1 and 2 is referred to as the first neural network model hereinafter, and the neural network model (e.g., the diffusion model) of FIGS. 1 and 2 is referred to as the second neural network model hereinafter.

Referring to FIG. 3, a processor according one or more embodiments may perform a plurality of denoising operations (e.g., (t-1)th to (t-n)th denoising operations (310-1 to 310-n, 320-1 to 320-n)) included in the m-th denoising group on an input image xₜ 300. In FIG. 3, the m-th denoising group is assumed as a target denoising group.

In an embodiment, the processor may optimize parameters (e.g., the quantization parameters) of the second neural network model to improve denoising performance of the second neural network model. The processor may reflect the errors accumulated in the plurality of denoising operations (included in the m-th denoising group) into an optimization process of the parameters of the second neural network model, thereby determining the parameters of the second neural network model (corresponding to the m-th denoising group).

In an embodiment, the processor may sequentially perform the plurality of denoising operations 310-1 to 310-n on the input image xₜ 300 using the first neural network model to generate a first image 330-n. For example, the processor may perform the denoising operation 310-1 on the input image xₜ 300 using the first neural network model to generate an image xₜ₋₁330-1, perform the denoising operation 310-2 on the image xₜ₋₁330-1 using the first neural network model to generate an image xₜ₋₂ 330-2, . . . , perform a denoising operation 310-n+1 on an image xₜ₋ₙ₊₂ using the first neural network model to generate an image xₜ₋ₙ₊₁ 330-n+1, and perform the denoising operation 310-n on the image xₜ₋ₙ₊₁ 330-n+1 using the first neural network model to generate a first image xₜ₋ₙ 330-n.

In an embodiment, the processor may sequentially perform a plurality of denoising operations 320-1 to 320-n on the input image xₜ 300 using the second neural network model to generate a second image 340-n. Here, the first neural network model may include the full precision model, the second neural network model may include the diffusion model, and the parameters of the second neural network model may include the quantization parameters. For example, the processor may perform a denoising operation 320-1 on the input image xₜ 300 using the second neural network model to generate an image Xₜ₋₁340-1, perform a denoising operation 320-2 on the image Xₜ₋₁340-1 using the first neural network model to generate an image Xₜ₋₂ 340-2, . . . , perform a denoising operation 320-n+1 on the image Xₜ₋ₙ₋₊₂ using the first neural network model to generate an image Xₜ₋ₙ₊₁ 340-n+1, and perform a denoising operation 320-n on the image Xₜ₋ₙ₊₁ 340-n+1 using the first neural network model to generate the second image Xₜ₋ₙ 340-n.

In an embodiment, the processor may calculate a loss function 350 between the first image xₜ₋₁330-n and the second image Xₜ₋ₙ 340-n in the m denoising group. Here, the loss function 350 of the m-th denoising group may be a function of the error (or difference value) between the first image xₜ₋₁330-n and the second image Xₜ₋ₙ 340-n. The loss function 350 of the m-th denoising group may correspond to an error accumulated in the process of performing the plurality of denoising operations 320-1 to 320-n (included in the m-th denoising group) by the second neural network model.

In an embodiment, the processor may optimize the parameters of the second neural network model by considering errors accumulated (i.e., the loss function 350) in the m-th denoising group. For example, the processor may determine parameters that minimize the errors accumulated (i.e., the loss function 350) in the m-th denoising group as the parameters of the second neural network model.

In an embodiment, the processor may calculate a gradient of the loss function 350 through the backpropagation from the loss function 350 of the m-th denoising group. The processor may determine (optimize) parameters that minimize the loss function 350 in the m-th denoising group based on the calculated gradient of the loss function 350 as the parameters of the second neural network model.

In an embodiment, the processor may calculate an approximate value of an intermediate gradient of the loss function 350 of the m-th denoising group based on the noise parameters. The processor may determine (optimize) parameters for minimizing the loss function 350 in the m-th denoising group based on the approximate value of the intermediate gradient of the loss function 350 as the parameters of the second neural network model. Through this, the processor may prevent overload that occurs during the parameter determination (optimization) process of the second neural network model and determine (optimize) parameters efficiently in terms of resources (e.g., storage space/capacity of memory). A detailed explanation of this is described below in FIGS. 5 and 6.

As described above, the electronic device according to the embodiment may calculate a gradient (or the approximate value of an intermediate gradient) for minimizing the loss function 350 for each denoising group, and determine the parameters of the second neural network model (e.g., the diffusion model) for each denoising group based on the calculated gradient (or the approximate value of the intermediate gradient).

Accordingly, the electronic device according to the embodiment may optimize the parameters of the second neural network model (e.g., the diffusion model) for each denoising group by considering errors accumulated in the plurality of denoising operations included in the denoising group, thereby optimizing the parameters of the second neural network model (e.g., the diffusion model) more precisely, thereby improving the noise removal performance and processing efficiency of the second neural network model (e.g., the diffusion model).

FIG. 4 is a diagram illustrating an operation of an electronic device according to an embodiment.

In detail, FIG. 4 is a block diagram illustrating an example of a parameter determination (optimization) operation of an electronic device according to an embodiment. In FIG. 4, the number of plurality of denoising operations included in the target denoising group is assumed to be M. Outputting a final image based on the first and second neural network models in FIG. 4 may refer to generating a final image by performing the plurality of denoising operations based on the first and second neural network models.

Referring to FIG. 4, in a case of an inference process (e.g., the denoising process) 410 of the second neural network model, the second neural network model (e.g., the diffusion model) may perform a first denoising operation on the input image X₁ to output an image Xₜ₋₁, . . . , and perform an M-th denoising operation on the output image Xₜ₋ₘ₊₁ to output a final image Xₜ₋ₘ. In this way, in the case of the inference process 410 of the second neural network model, the second neural network model may output the final image by performing M denoising operations. However, as the second neural network model receives again as an input the image output from the previous denoising operation and performs the next denoising operation, errors generated in M denoising operations may be accumulated. Accumulated errors may degrade performance of the second neural network model (e.g., denoising performance). It is necessary to determine the parameters of the second neural network model (e.g., the diffusion model) by considering errors accumulated in a parameter optimization process (i.e., the parameter determination process) 450 of the second neural network model (e.g., the diffusion model).

Therefore, in the parameter optimization process 450 of the second neural network model according to an embodiment, the first neural network model may simulate the inference process 410 of the second neural network model to receive again, as an input, the image output from the previous denoising operation and perform the next denoising operation. The first neural network model may output a final image by performing M denoising operations, identical to the inference process 410 of the second neural network model. For example, the first neural network model (e.g., the full precision model) performs the first denoising operation on the input image xₜ to output the image xₜ₋₁, . . . , the first neural network model (e.g., the full precision model) may perform the M-th denoising operation on an image xₜ₋ₘ₊₁ to output the final image xₜ₋ₘ.

In this way, the processor may calculate the gradient of the loss function (or the approximate value of the intermediate gradient) between the final image xₜ₋ₘ (e.g., the first image) generated by performing the M denoising operations by the first neural network model and the final image Xₜ₋ₘ (e.g., the second image) generated by performing the M denoising operations by the second neural network model, and determine the parameters of the second neural network model based on the calculated gradient of the loss function (or the approximate value of the intermediate gradient). Through this, the electronic device (processor) according to an embodiment may determine (optimize) the parameters of the second neural network model (e.g., the diffusion model) for each denoising group, based on the accumulated error for each denoising group (i.e., the accumulated error in multiple denoising operations included in each denoising group).

FIGS. 5 and 6 are diagrams illustrating operations of an electronic device, according to one or more embodiments.

In detail, FIG. 5 illustrates an operation of calculating an intermediate gradient approximation value of the loss function by the electronic device according to an embodiment, and FIG. 6 illustrates a calculation process of the intermediate gradient approximation value of the loss function of FIG. 5. Any description that overlaps with descriptions already given is omitted.

In FIGS. 5 and 6, the overall denoising operations for the overall denoising processing may be grouped into a certain number (e.g., q) of groups (including the first denoising group to the qth denoising group) by the processor of the electronic device. In this case, as the order of the denoising group increases (i.e., from earlier to later stages in the sequence), an amount of noise remaining in the output image of the denoising group may decrease. In FIGS. 5 and 6, it is assumed that the target denoising group is the m-th denoising group, and the m-th denoising group includes n denoising operations (e.g., the (t-1)th denoising operation to the (t-n)th denoising operation).

Referring to FIG. 5, the processor according to an embodiment may calculate the gradient of the loss function 350 to determine (optimize) the parameters of the second neural network model for minimizing the loss function 350 of the m-th denoising group. However, when the processor directly calculates the gradient of the loss function 350, there is a problem that a large amount of memory is required to store all intermediate gradients during a backpropagation process (i.e., a high memory complexity), causing a significant overload on the processor. For example, when directly calculating the gradient of the loss function 350 through the backpropagation (see FIG. 5), the processor must directly calculate all intermediate gradients of the plurality of denoising operations (e.g., from the (t-n)th denoising operation 320-n to the first denoising operation 320-1) included in the m-th denoising group (i.e., the target denoising group).

Referring to FIGS. 5 and 6, instead of directly calculating the gradient of the loss function 350, the processor according to the embodiment may calculate the gradient of the loss function 350 through the approximate value of the intermediate gradient (corresponding to a portion P of FIG. 6) of the loss function 350 based on the noise parameter. For example, the processor may calculate the approximate value of the intermediate gradient of the loss function 350 in the target denoising group based on the following Equations, and calculate the gradient of the loss function 350 based on the calculated approximate value of the intermediate gradient.

xₜ₋₁=\sqrt{aₜ₋₁}x₀+\sqrt{1−aₜ₋₁}∈ [Equation 1]

xₜ₋ₙ=\sqrt{aₜ₋ₙ}x₀+\sqrt{1−aₜ₋ₙ}∈ [Equation 2]

xₜ₋₁ denotes an image (input image) including noise in the (t−1)th denoising operation, xₜ₋ₙ denotes an image (input image) including noise in the (t-n)th denoising operation, x₀ denotes an image with noise removed (original image), and a denotes noise parameters corresponding to each denoising operation. Equation 2 may be summarized as Equation 3 below based on Equation 1.

$$\begin{matrix}{x}_{t - n} = \sqrt{{a}_{t - n}} {x}_{0} + \sqrt{1 - {a}_{t - n}} ∈ \\ = \sqrt{{a}_{t - n}} ( \frac{{x}_{t - 1}}{\sqrt{{a}_{t - 1}}} - \frac{\sqrt{1 - {a}_{t - 1}}}{\sqrt{{a}_{t - 1}}} ∈ ) + \sqrt{1 - {a}_{t - n}} ∈ \\ = \frac{\sqrt{{a}_{t - n}}}{\sqrt{{a}_{t - 1}}} {x}_{t - 1} + ( - \frac{\sqrt{{a}_{t - n}} \sqrt{1 - {a}_{t - 1}}}{\sqrt{{a}_{t - 1}}} + \sqrt{1 - {a}_{t - n}} ∈\end{matrix} \qquad [ Equation 3 ]$$

Among the gradients of the loss function 350, the intermediate gradient

$$( \frac{\partial {x}_{t - n}}{\partial {x}_{t - 1}} )$$

(corresponding to the portion P of FIG. 6) (corresponding to the (t−1)th denoising operation to the (t-n)th denoising operation) may be calculated as in the following Equation 4.

$$\frac{\partial {x}_{t - n}}{\partial {x}_{t - 1}} \approx \frac{\sqrt{{a}_{t - n}}}{\sqrt{{a}_{t - 1}}} \qquad [ Equation 4 ]$$

aₜ₋ₙ may denote a noise parameter corresponding to the (t-n)th denoising operation, and aₜ₋₁ may denote a noise parameter corresponding to the (t−1)th denoising operation.

A gradient

$$\frac{\partial {x}_{t - n}}{\partial θ}$$

of the loss function 350 may be calculated based on an approximate value

$$\frac{\sqrt{{a}_{t - n}}}{\sqrt{{a}_{t - 1}}}$$

of an intermediate gradient

$$\frac{\partial {x}_{t - n}}{\partial {x}_{t - 1}}$$

of the loss function 350, as in the following Equation 5.

$$\begin{matrix}\frac{\partial {x}_{t - n}}{\partial θ} = \frac{\partial {x}_{t - n}}{\partial {x}_{t - n + 1}} \frac{\partial {x}_{t - n + 1}}{\partial {x}_{t - n + 2}} … \frac{\partial {x}_{t - 2}}{\partial {x}_{t - 1}} \frac{\partial {x}_{t - 1}}{\partial θ} \\ = \frac{\partial {x}_{t - n}}{\partial {x}_{t - 1}} \frac{\partial {x}_{t - 1}}{\partial θ} \\ \approx \frac{\sqrt{{a}_{t - n}}}{\sqrt{{a}_{t - 1}}} \frac{\partial {x}_{t - 1}}{\partial θ}\end{matrix} \qquad [ Equation 5 ]$$

Accordingly, the processor according to the embodiment may maximize memory space efficiency (e.g., reduce the memory complexity from O(1) to O(1)) and prevent occurrence of overload on the processor during direct calculation of the gradient by calculating the gradient

$$\frac{\partial {x}_{t - n}}{\partial θ}$$

of the loss function 350 based on the approximate value

$$\frac{\sqrt{{a}_{t - n}}}{\sqrt{{a}_{t - 1}}}$$

of the intermediate gradient

$$\frac{\sqrt{{a}_{t - n}}}{\sqrt{{a}_{t - 1}}} .$$

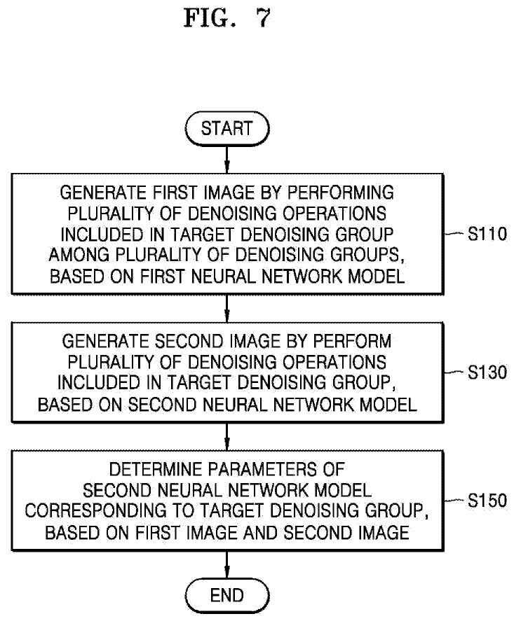

FIG. 7 is a flowchart illustrating an operating method of an electronic device, according to an embodiment.

Referring to FIG. 7, the operating method of the electronic device for determining (optimizing) the parameters of the second neural network model by denoising group may include operations S110 to S150. Any description that overlaps with descriptions already given is omitted.

In operation S110, the processor of the electronic device according to an embodiment may generate the first image by performing the plurality of denoising operations included in the target denoising group among the plurality of denoising groups, using the first neural network model.

In operation S130, the processor of the electronic device may generate the second image by perform the plurality of denoising operations included in the target denoising group, using the second neural network model. Here, the first neural network model may include the full precision model. In an embodiment, the processor may input the image generated by the first neural network model in the previous denoising operation to the first neural network model in the next denoising operation to generate the first image, and may input the image generated by the second neural network model in the previous denoising operation to the second neural network model in the next denoising operation to generate the second image.

In operation S150, the processor of the electronic device may determine the parameters of the second neural network model corresponding to the target denoising group, based on the first image and the second image. Here, the second neural network model may include the diffusion model, and the parameters of the second neural network model may be quantization parameters of the diffusion model.

In an embodiment, the processor may group the entire denoising operations required for denoising processing into a predetermined number of denoising groups.

In an embodiment, the processor may calculate the loss function between the first image and the second image in the target denoising group, calculate the gradient of the loss function through the backpropagation from the loss function, and determine the parameters of the second neural network model corresponding to the target denoising group based on the gradient of the loss function.

In an embodiment, the processor may identify target denoising operations associated with intermediate gradients of the loss function, receive target noise parameters corresponding to the target denoising operations from among the plurality of noise parameters from a memory, calculate the approximate value of the intermediate gradient based on the target noise parameters, and calculate the gradient of the loss function based on the approximate value of the intermediate gradient. Here, each of the plurality of noise parameters may represent the level of noise in the image generated in each of the plurality of denoising operations. Additionally, the plurality of denoising operations may be mapped to the plurality of noise parameters respectively corresponding to the plurality of denoising operations and stored in the memory of the electronic device.

In an embodiment, the processor may store the target denoising group and the parameters of the second neural network model corresponding to the target denoising group by mapping the target denoising group and the parameters of the second neural network model to each other.

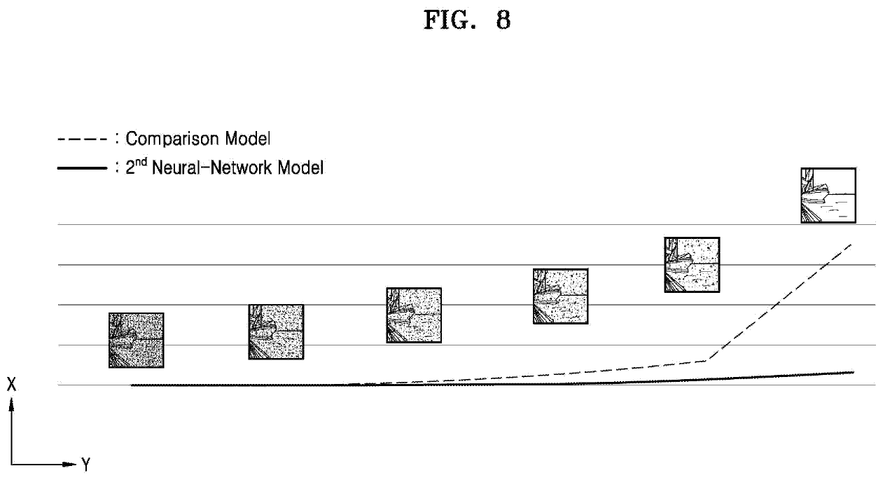

FIG. 8 is a diagram for comparing an operation of an electronic device according to an embodiment with an operation of an electronic device according to a comparative example.

In the graph of FIG. 8, an X-axis may represent the accumulated error (e.g., accumulated quantization error) during the plurality of denoising operations, and a Y-axis may represent corresponding time points at which the plurality of denoising operations are sequentially performed. It may be confirmed that more denoising operations are performed toward the right in the graph, so that the amount of noise included in the image decreases. Any description that overlaps with descriptions already given is omitted.

It is assumed that the electronic device according to the comparative example does not reflect the errors accumulated in the plurality of denoising operations during the parameter determination (optimization) process of a comparison model.

In FIG. 8, a dashed line illustrates a first error between the final image generated by performing the plurality of denoising operations by the electronic device according to the comparative example and the final image generated by performing the plurality of denoising operations on the first neural network model (e.g., the full precision model), and the solid line illustrates a second error between the final image generated by performing the plurality of denoising operations by the electronic device according to an embodiment and the final image generated by performing the plurality of denoising operations on the first neural network model (e.g., the full precision model). As shown in the graph of FIG. 8, it may be confirmed that the second error according to the embodiment is less than the first error according to the comparative example. Additionally, it may be confirmed that a size of the first error according to the comparative example increases as the plurality of denoising operations are performed cumulatively.

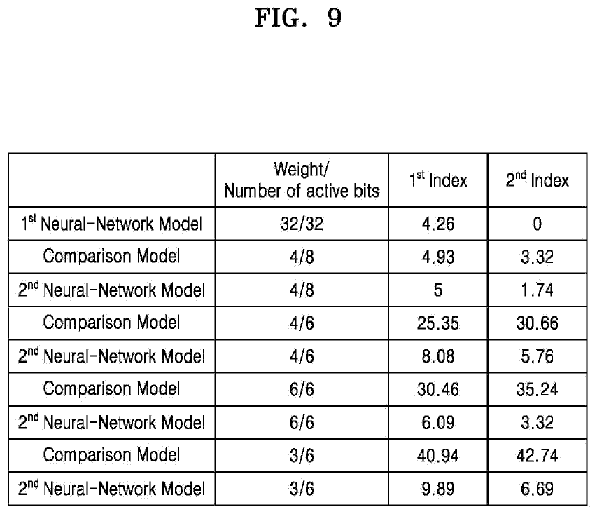

FIG. 9 is a diagram for comparing an operation of an electronic device, according to an embodiment with an operation of an electronic device according to a comparative example.

In FIG. 9, the first neural network model (e.g., the full precision model) may have weight/activation bits set to 32 bits/32 bits, and the comparison model according to the comparative example and the second neural network model according to an embodiment may have weight/activation bits set to any one of 4 bits/8 bits, 4 bits/6 bits, 6 bits/6 bits, or 3 bits/6 bits. Any description that overlaps with descriptions already given is omitted.

In FIG. 9, a first index may be an evaluation index (e.g., FID) indicating a degree of similarity between the final image generated by performing the plurality of denoising operations by the second neural network model or the comparison model and actual image data, and a second index may be an evaluation index (e.g., FID2FP32) indicating the degree of similarity between the final image generated by performing the plurality of denoising operations by the second neural network model or the comparison model and the final image generated by performing the plurality of denoising operations by the first neural network model. In this case, the smaller a first index value, the more similar to the actual image data, and the smaller a second index value, the more similar to the final image generated by the first neural network model (e.g., the full precision model).

Referring to FIG. 9, for combinations between various weights/activation bits, the results of evaluating the denoising performance of the comparison model according to the comparative example and the denoising performance of the second neural network model according to an embodiment are illustrated. As illustrated in FIG. 9, in most combinations between weight/activation bits, it may be confirmed that the first index value for the second neural network model according to an embodiment is less than the first index value of the comparison model according to the comparative example. In addition, in most combinations between weight/activation bits, it may be confirmed that the second index value for the second neural network model according to an embodiment is less than the second index value of the comparison model according to the comparative example.

The electronic device (processor) according to an embodiment may improve noise removal performance of the second neural network model by determining (optimizing) the parameters of the second neural network model by reflecting errors accumulated in the plurality of denoising operations included in the denoising group.

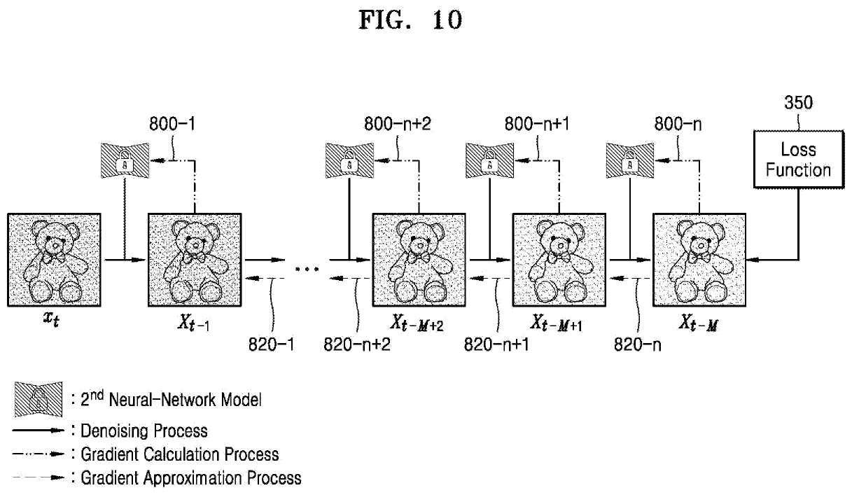

FIG. 10 is a diagram for comparing an operation of an electronic device according to an embodiment with an operation of an electronic device according to a comparative example.

FIG. 10 illustrates a comparison between the operation of the electronic device according to the comparative example and the electronic device according to an embodiment in the process of calculating the gradient of the loss function 350 between the first neural network model and the second neural network model.

Because the electronic device according to the comparative example must store all intermediate gradients for each denoising operation (e.g., 800-1, 800-n+2, . . . , 800-n+1, 800-n) in the memory, the memory complexity increases in proportion to the number of denoising operations, and a computational overload occurs in the processor, which limits the implementation of a large-scale second neural network model (e.g., the diffusion model).

In contrast, the electronic device according to the embodiment may calculate the approximate value of the intermediate gradient of the loss function 350 based on the noise parameters pre-stored in the memory. Here, the noise parameter may be a parameter (scalar component) respectively corresponding to the plurality of denoising operations. For example, the electronic device may perform a gradient approximation process (e.g., 820-1, 820-n+2, . . . , 820-n+1, 820-n) through the backpropagation over the plurality of denoising operations, based on the noise parameters. This has technical effect of enabling implementation of large-scale second neural network models (e.g., the diffusion models) by reducing the memory complexity and preventing the computational overload on the processor. In particular, the method of calculating the approximate value of the intermediate gradient of the loss function 350 according to the embodiment may be applied to various neural network models regardless of an inference method of the neural network model.

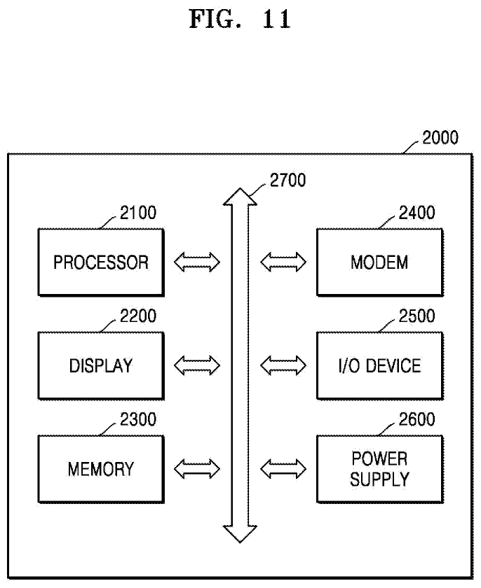

FIG. 11 is a block diagram illustrating an electronic device according to an embodiment.

Referring to FIG. 11, a system 2000 for performing denoising on the input image may include a processor 2100, a display 2200, a memory 2300, a modem 2400, an input/output device 2500, and a power supply 2600. The system 2000 of FIG. 11 may correspond to a system on chip (SoC) for performing denoising on the input image. For convenience of explanation in FIG. 11, the processor 2100, the display 2200, the memory 2300, the modem 2400, the input/output device 2500, and the power supply 2600 are illustrated as being included within the system (or SoC) 2000, but are not limited thereto. At least one of the processor 2100, the display 2200, the memory 2300, the modem 2400, the input/output device 2500, and the power supply 2600 according to an embodiment may be implemented as an external configuration of the system (or SoC) 2000 as well as within the system (or SoC) 2000.

The processor 2100 is a device that controls the overall operation of the system 2000. The processor 2100 may perform data processing on input data by running an application. The application may include a plurality of data operations related to performing a task, such as arithmetic operations, convolution operations, and polling operations. For example, when the processor 2100 performs a task based on a neural network (e.g., converting data transmitted and received between a plurality of neural network models into parameters and transmitting and receiving the parameters), a plurality of data operations based on at least one of various types of neural networks included in the application and an input and output sizes, weights, biases, etc. of the plurality of data operations may be included.

The processor 2100 may be implemented as a central processing unit (CPU), a graphics processing unit (GPU), a digital signal processor (DSP), a field programmable gate array (FPGA), an application specific integrated circuit (ASIC), a neural processing unit (NPU), etc. However, the processor 2100 is not limited thereto and may be implemented with various types of circuits that perform data processing, such as data operations, in parallel as required to perform assigned tasks.

The processor 2100 according to an embodiment may group all denoising operations into the plurality of denoising groups, identify the target denoising group among the plurality of denoising groups by sequentially selecting one group from the plurality of denoising groups according to a predetermined order (e.g., iteratively selecting groups starting from a final time step to and initial time step), perform the plurality of denoising operations included in the target denoising group, using the first neural network model to generate the first image, perform the plurality of denoising operations using the second neural network model to generate the second image, and determine (optimize) parameters of the second neural network model corresponding to the target denoising group, based on the loss function between the first image and the second image. Here, upon completion of determining the parameters for a current target denoising group, the processor 2100 may identify a next group in the sequence as a new target denoising group for a next target denoising group for a subsequent iteration.

In order to determine the parameters of the second neural network model, the processor 2100 according to the embodiment may calculate the approximate value of the intermediate gradient of the loss function by using target noise parameters associated with the intermediate gradient of the loss function among the plurality of noise parameters, and calculate the gradient of the loss function based on the approximate value of the intermediate gradient, and determine (optimize) the parameters of the second neural network model based on the gradient of the loss function.

The display 2200 may output the data processing results of the processor 2100 to the user through a display panel.

The memory 2300 may include volatile memory such as static random access memory (SRAM), dynamic RAM (DRAM), synchronous RAM (SDRAM), and/or nonvolatile memory such as phase-change RAM (PRAM), magneto-resistive RAM (MRAM), resistive RAM (ReRAM), ferro-electric RAM (FRAM).

The memory 2300 according to an embodiment may store the first neural network model (e.g., the full precision model), the second neural network model (e.g., the diffusion model), and the plurality of noise parameters respectively corresponding to the plurality of denoising operations.

The memory 2300, the processor 2100, the display 2200, the modem 2400, the input/output device 2500, and the power supply 2600 may be connected to each other through a channel 2700, and the channel 2700 may be used for data exchange between the memory 2300, the processor 2100, the display 2200, the modem 2400, the input/output device 2500, and the power supply 2600.

The modem 2400 may support at least one of various wireless/wired communication protocols to communicate with external devices of the system 2000 or an external system. The input/output device 2500 may mediate communication between a user and the system 2000 through a user interface including various input/output interfaces. The power supply 2600 may perform power supply and overall power-related management of the system 2000.

By using a system 2000 for performing denoising on an image according to the inventive concept as described above, the parameters of the second neural network model may be determined (optimized) by considering errors accumulated in the plurality of denoising operations. Through this, the system 2000 according to the inventive concept may improve the denoising performance of the system 2000 by precisely adjusting the parameters.

In addition, by using the system 2000 that performs denoising on an image according to the inventive concept, efficiency of resources (e.g., memory storage space/capacity) may be maximized by calculating the intermediate gradient of the loss function between the first neural network model and the second neural network model by approximating the intermediate gradient in the process of determining (optimizing) the parameters of the second neural network model.

In one or more embodiments of the present disclosure, an electronic device may include: a memory storing one or more instructions to operate a first neural network model and a second neural network model; and a processor configured to execute the one or more instructions to: generate a first image by performing a plurality of denoising operations included in a target denoising group among a plurality of denoising groups, via the first neural network model; generate a second image by performing the plurality of denoising operations included in the target denoising group, via the second neural network model; and determine parameters of the second neural network model corresponding to the target denoising group, based on a comparison between the first image and the second image.

The processor may be further configured to group entire denoising operations required for a denoising process into a predetermined number of the plurality of denoising groups.

To generate the first image and the second image, the processor may be further configured to: input an image generated by the first neural network model in a previous denoising operation into the first neural network model in a next denoising operation to generate the first image; and input an image generated by the second neural network model in the previous denoising operation into the second neural network model in the next denoising operation to generate the second image.

To determine the parameters of the second neural network model, the processor is further configured to: calculate a loss function between the first image and the second image in the target denoising group; calculate a gradient of the loss function through backpropagation from the loss function; and determine the parameters of the second neural network model corresponding to the target denoising group, based on the gradient of the loss function.

The memory is further configured to store the plurality of denoising operations and a plurality of noise parameters respectively corresponding to the plurality of denoising operations by mapping the plurality of denoising operations to the plurality ofnoise parameters, respectively.

To calculate the gradient, the processor may be further configured to: identify target denoising operations associated with an intermediate gradient of the loss function, wherein the target denoising operations correspond to the plurality of denoising operations included in the target denoising group; request, from the memory, target noise parameters corresponding to the target denoising operations among a plurality of noise parameters to the memory; calculate an approximate value of the intermediate gradient, based on the target noise parameters received from the memory; and calculate the gradient of the loss function, based on the approximate value of the intermediate gradient.

The processor may be further configured to store the target denoising group and the parameters of the second neural network model corresponding to the target denoising group in the memory by mapping the target denoising group to the parameters of the second neural network model.

Each of the plurality of noise parameters may represent a level of noise in an image generated in each of the plurality of denoising operations.

The first neural network model may have a greater precision than the second neural network model, the second neural network model may include a diffusion model, and the parameters of the second neural network model may be quantization parameters of the diffusion model.

In one or more embodiments of the present disclosure, an operating method of an electronic device may include: generating a first image by performing a plurality of denoising operations included in a target denoising group among a plurality of denoising groups, via a first neural network model; generating a second image by performing the plurality of denoising operations included in the target denoising group, via a second neural network model; and determining parameters of the second neural network model corresponding to the target denoising group, based on a comparison between the first image and the second image.

The operating method may include grouping all denoising operations required for denoising processing into a predetermined number of denoising groups.

The generating of the first image and the second image may include: generating the first image by inputting an image generated by the first neural network model in a previous denoising operation into the first neural network model in a next denoising operation; and generating the second image by inputting an image generated by the second neural network model in the previous denoising operation into the second neural network model in the next denoising operation.

The determining of the parameters of the second neural network model may include: calculating a loss function between the first image and the second image in the target denoising group; calculating a gradient of the loss function through backpropagation from the loss function; and determining the parameters of the second neural network model corresponding to the target denoising group, based on the gradient of the loss function.

A memory of the electronic device may be configured to store the plurality of denoising operations and a plurality of noise parameters respectively corresponding to the plurality of denoising operations by mapping the plurality of denoising operations to the plurality of noise parameters, respectively.

The calculating of the gradient of the loss function may include: identifying target denoising operations associated with intermediate gradients of the loss function, wherein the target denoising operations correspond to the plurality of denoising operations included in the target denoising group; receiving target noise parameters corresponding to the target denoising operations among a plurality of noise parameters from a memory; calculating an approximate value of the intermediate gradient, based on the target noise parameters; and calculating the gradient of the loss function, based on the approximate value of the intermediate gradient.

The operating method may include storing the target denoising group and the parameters of the second neural network model corresponding to the target denoising group by mapping the target denoising group to the parameters of the second neural network model.

Each of the plurality of noise parameters represents a noise level in an image generated through each of the plurality of denoising operations.

The first neural network model may have a greater precision than the second neural network model, the second neural network model may include a diffusion model, and the parameters of the second neural network model may be quantization parameters of the diffusion model.

In one or more embodiments of the present disclosure, a system for performing denoising on an image may include: a memory storing one or more instructions to operate a first neural network model and a second neural network model, and a plurality of noise parameters respectively corresponding to a plurality of denoising operations; and a processor configured to execute the one or more instructions to: group an initial set of denoising operations into a plurality of denoising groups; identify a target denoising group among the plurality of denoising groups; generate a first image by performing the plurality of denoising operations included in the target denoising group, via the first neural network model; generate a second image by performing the plurality of denoising operations, via the second neural network model; and determine parameters of the second neural network model corresponding to the target denoising group, based on a loss function between the first image and the second image.

To determine the parameters of the second neural network model, the processor may be further configured to: calculate an approximate value of an intermediate gradient of the loss function by using target noise parameters associated with the intermediate gradient of the loss function among the plurality of noise parameters; calculate a gradient of the loss function based on the approximate value of the intermediate gradient; and determine the parameters of the second neural network model based on the gradient of the loss function.

While the inventive concept has been particularly shown and described with reference to embodiments thereof, it will be understood that various changes in form and details may be made therein without departing from the spirit and scope of the following claims.

What is claimed is:

1. An electronic device comprising:
a memory storing one or more instructions to operate a first neural network model and a second neural network model; and
a processor configured to execute the one or more instructions to:
generate a first image by performing a plurality of denoising operations included in a target denoising group among a plurality of denoising groups, via the first neural network model;
generate a second image by performing the plurality of denoising operations included in the target denoising group, via the second neural network model; and
determine parameters of the second neural network model corresponding to the target denoising group, based on a comparison between the first image and the second image.

2. The electronic device of claim 1, wherein the processor is further configured to group an initial set of denoising operations required for a denoising process into a predetermined number of the plurality of denoising groups.

3. The electronic device of claim 1, wherein, to generate the first image and the second image, the processor is further configured to:
input an image generated by the first neural network model in a previous denoising operation into the first neural network model in a next denoising operation to generate the first image; and
input an image generated by the second neural network model in the previous denoising operation into the second neural network model in the next denoising operation to generate the second image.

4. The electronic device of claim 1, wherein, to determine the parameters of the second neural network model, the processor is further configured to:
calculate a loss function between the first image and the second image in the target denoising group;
calculate a gradient of the loss function through backpropagation from the loss function; and
determine the parameters of the second neural network model corresponding to the target denoising group, based on the gradient of the loss function.

5. The electronic device of claim 1, wherein the memory is further configured to store the plurality of denoising operations and a plurality of noise parameters respectively corresponding to the plurality of denoising operations by mapping the plurality of denoising operations to the plurality of noise parameters, respectively.

6. The electronic device of claim 4, wherein, to calculate the gradient, the processor is further configured to:
identify target denoising operations associated with an intermediate gradient of the loss function, wherein the target denoising operations correspond to the plurality of denoising operations included in the target denoising group;
request, from the memory, target noise parameters corresponding to the target denoising operations among a plurality of noise parameters to the memory;
calculate an approximate value of the intermediate gradient, based on the target noise parameters received from the memory; and
calculate the gradient of the loss function, based on the approximate value of the intermediate gradient.

7. The electronic device of claim 1, wherein the processor is further configured to store the target denoising group and the parameters of the second neural network model corresponding to the target denoising group in the memory by mapping the target denoising group to the parameters of the second neural network model.

8. The electronic device of claim 5, wherein each of the plurality of noise parameters represents a level of noise in an image generated in each of the plurality of denoising operations.

9. The electronic device of claim 1,
wherein the first neural network model has a greater precision than the second neural network model,
the second neural network model comprises a diffusion model, and
the parameters of the second neural network model are quantization parameters of the diffusion model.

10. An operating method of an electronic device, the operating method comprising:
generating a first image by performing a plurality of denoising operations included in a target denoising group among a plurality of denoising groups, via a first neural network model;
generating a second image by performing the plurality of denoising operations included in the target denoising group, via a second neural network model; and
determining parameters of the second neural network model corresponding to the target denoising group, based on a comparison between the first image and the second image.

11. The operating method of claim 10, further comprising
grouping an initial set of denoising operations required for denoising processing into a predetermined number of the plurality of denoising groups.

12. The operating method of claim 10, wherein the generating of the first image and the second image comprises:
generating the first image by inputting an image generated by the first neural network model in a previous denoising operation into the first neural network model in a next denoising operation; and
generating the second image by inputting an image generated by the second neural network model in the previous denoising operation into the second neural network model in the next denoising operation.

13. The operating method of claim 10, wherein the determining of the parameters of the second neural network model comprises:
calculating a loss function between the first image and the second image in the target denoising group;
calculating a gradient of the loss function through backpropagation from the loss function; and
determining the parameters of the second neural network model corresponding to the target denoising group, based on the gradient of the loss function.

14. The operating method of claim 10, wherein a memory of the electronic device is configured to
store the plurality of denoising operations and a plurality of noise parameters respectively corresponding to the plurality of denoising operations by mapping the plurality of denoising operations to the plurality of noise parameters, respectively.

15. The operating method of claim 13, wherein the calculating of the gradient of the loss function comprises:
identifying target denoising operations associated with intermediate gradients of the loss function, wherein the target denoising operations correspond to the plurality of denoising operations included in the target denoising group;
receiving target noise parameters corresponding to the target denoising operations among a plurality of noise parameters from a memory;
calculating an approximate value of the intermediate gradient, based on the target noise parameters; and
calculating the gradient of the loss function, based on the approximate value of the intermediate gradient.

16. The operating method of claim 10, further comprising
storing the target denoising group and the parameters of the second neural network model corresponding to the target denoising group by mapping the target denoising group to the parameters of the second neural network model.

17. The operating method of claim 14, wherein each of the plurality of noise parameters represents a noise level in an image generated through each of the plurality of denoising operations.

18. The operating method of claim 10,
wherein the first neural network model has a greater precision than the second neural network model,
the second neural network model comprises a diffusion model, and
the parameters of the second neural network model are quantization parameters of the diffusion model.

19. A system for performing denoising on an image, the system comprising:
a memory storing one or more instructions to operate a first neural network model and a second neural network model, and a plurality of noise parameters respectively corresponding to a plurality of denoising operations; and
a processor configured to execute the one or more instructions to:
group an initial set of denoising operations into a plurality of denoising groups;
identify a target denoising group among the plurality of denoising groups;
generate a first image by performing the plurality of denoising operations included in the target denoising group, via the first neural network model;
generate a second image by performing the plurality of denoising operations, via the second neural network model; and
determine parameters of the second neural network model corresponding to the target denoising group, based on a loss function between the first image and the second image.

20. The system of claim 19, wherein, to determine the parameters of the second neural network model, the processor is further configured to:
calculate an approximate value of an intermediate gradient of the loss function by using target noise parameters associated with the intermediate gradient of the loss function among the plurality of noise parameters;
calculate a gradient of the loss function based on the approximate value of the intermediate gradient; and
determine the parameters of the second neural network model based on the gradient of the loss function.
